(19) United States
(12) Patent Application Publication
(10) Pub. No.: US 2024/0330474 A1
(43) Pub. Date: Oct. 3, 2024

(54) POLICY-BASED BLOCKING OF VULNERABLE SOFTWARE INSTALLATIONS USING A PROXY

(71) Applicant: CLOUDFLARE, INC., San Francisco, CA (US)

(72) Inventors: Andrew Taylor Plunk, Austin, TX (US); Ankur Aggarwal, San Francisco, CA (US); Adrian Mateo Maceiras, Austin, TX (US); Jesse Kipp, Austin, TX (US)

(21) Appl. No.: 18/190,582

(22) Filed: Mar. 27, 2023

(51) Int. Cl. G06F 21/57; G06F 21/54; G06F 21/55

(52) U.S. Cl. CPC G06F 21/577; G06F 21/54; G06F 21/554

(57) ABSTRACT

A proxy server receives a request from a client network application executing on a client device. The proxy server detects that the request is for a software dependency installation package. The proxy server determines a risk score associated with the software dependency installation package. Based on the risk score associated with the software dependency installation package, the proxy server determines that the software dependency installation package violates a policy. When the software dependency installation package violates the policy, the proxy server blocks the request and stores a log entry in an auditing system including data indicating the blocking of the request.

### FIELD

Embodiments of the invention relate to the field of network communications, and more specifically, to using a proxy server configured with security policies to block vulnerable software installations.

### BACKGROUND

Managers of private networks are concerned with maintaining high security, performance, and reliability of their private network systems (e.g., client devices, servers, etc.). Preventing users from having unfettered or unregulated access to the internet can ensure vulnerable or malicious internet resources (e.g., webpages, installers, etc.) do not infiltrate the private network.

A forward proxy is an internet-facing proxy that sits between user devices and the internet and intercepts any network traffic from the user devices. For example, forward proxies receive requests (e.g., HTTP requests) from user devices and then transmit the received requests on the user's behalf. The forward proxy can then retrieve data from a server in response to the requests and send the responses to the user devices.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary networked system according to some embodiments described herein;

FIG. 2 illustrates an exemplary networked system according to some embodiments described herein;

FIG. 3 is a flow diagram that illustrates exemplary operations for performing security operations on a request for a software dependency installation in a software dependency management system by a proxy server according to an embodiment; and

FIG. 4 illustrates a block diagram for an exemplary data processing system that may be used in some embodiments.

### DESCRIPTION OF EMBODIMENTS

The embodiments described herein provide mechanisms for enforcing security policies on software dependency installation packages to prevent the installation of vulnerable dependencies in developer, CI, and/or production systems. A proxy server enforces policies to determine whether to allow or block vulnerable software from being downloaded and installed to a computing device, which can include a user's personal computer or a server used to build or package software (e.g., a build system) for a production deployment. Embodiments can also use policies to determine whether to allow or block the uploading of vulnerable software to a dependency management system.

In one embodiment, a proxy server receives a request (e.g., an HTTP request, an FTP request, an SFTP request, an SSH request, etc.) from a client network application executing on a client device, where the request includes a request to download a software dependency installation package. The proxy server analyzes the request and accesses a vulnerability management database or service to retrieve properties and/or threat assessments of the software dependency installation package (e.g., risk scores, confidence scores, software licenses, etc.). Using the properties and threat assessments, the proxy server determines whether the software dependency installation package violates any policies. When the software dependency installation package violates one or more policies, the request can be denied and the software dependency installation package is prevented from being installed. When the software dependency installation package does not violate policies, the request is allowed and the software dependency installation package is allowed to be installed.

Embodiments of the invention provide many technical advantages, in addition to addressing the deficiencies of previous solutions. For example, improvements to the security of resources in a software dependency management system can be realized by utilizing a proxy server to prevent the download or upload of vulnerable installation packages to software dependency management systems when they violate security policies. Further, vulnerable software transmissions can be blocked in all network requests originating from a monitored machine (e.g., because of a transparent proxy), where previous solutions typically only blocked requests to specific network addresses because they do not proxy all of the client's traffic. Additionally, embodiments of the invention are less susceptible to malicious or incorrect configurations on the client's machine. Previous solutions required per-package manager client-side configuration to instrument malicious software monitoring. The transparent proxy approach instead accepts all client traffic, performing policy decisions and per-package manager configurations server-side. The configurations defining policies can further be defined once and applied across multiple or all package managers rather than being defined for each package manager separately.

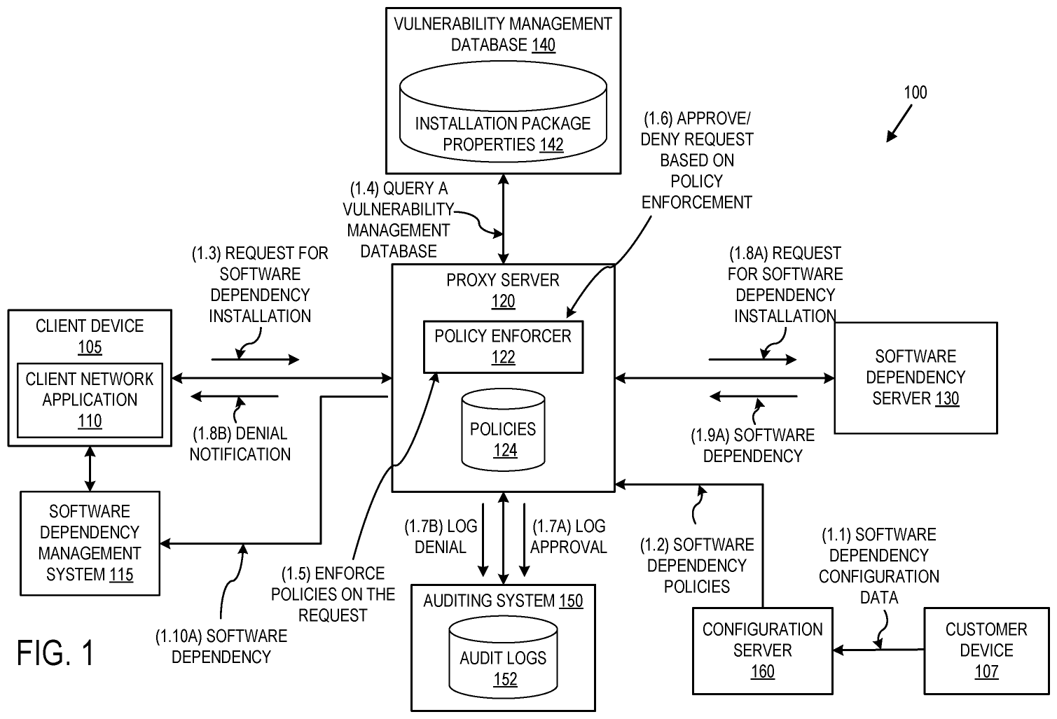

FIG. 1 illustrates an exemplary networked system according to some embodiments described herein. The exemplary networked system 100 illustrated in FIG. 1 includes a proxy server 120 situated between a client device 105 and a software dependency server 130. The exemplary networked system 100 also includes a vulnerability management database 140, an auditing system 150, and a configuration server 160 that are connected and/or communicate with the proxy server 120. The embodiment depicted in FIG. 1 illustrates operations for handling requests from the client device 105 to download and install software dependency installation packages to a software dependency management system 115.

Examples of client device 105 and customer device 107 include computing devices (e.g., laptops, workstations, smartphones, palm tops, mobile phones, tablets, gaming systems, set top boxes, wearable devices, electronic devices, etc.) that are capable of transmitting and/or receiving network traffic. In some embodiments, client device 105 executes a client network application 110 that is capable of transmitting and/or receiving network traffic. For example, the client network application 110 may include a web browser or other application that can send requests to access and display network resources, including software dependency installations.

In one embodiment, the configuration server 160 receives policies configuration data from the customer device 107 at operation 1.1. In one embodiment, the configuration server 160 allows a user of the customer device 107 to configure settings and parameters for security policies that apply to software dependency installation requests and software dependency upload requests from the client device 105. The configuration data can be used by the configuration server 160 to create policies defining a security posture for client devices (e.g., client device 105). An example policy includes allowing software installation if the software has a Common Vulnerabilities and Exposures (CVE) score of “Medium” or lower (e.g., a score of less than 4 out of 10).

In some embodiments, the configuration server 160 receives policies configuration data to, additionally or alternatively, configure settings and parameters for software license compliance policies that apply to software dependency installation requests and software dependency upload requests from the client device 105 (e.g., client device 105). The configuration data can be used by the configuration server 160 to create policies for enforcing software license compliance for client devices. An example policy includes allowing software installation if the software uses a permissive license such as the MIT license, while prohibiting software dependencies that use copyleft licenses such as European Union Public Licenses (EUPL).

After the configuration server 160 generates the software dependency policies, the configuration server 160 can send the software dependency policies to the proxy server at operation 1.2 for storage in a policies database 124.

A request for a software dependency installation is received at the proxy server 120 from client network application 110 at operation 1.3. The request can be generated in response to a user, while logged into a software dependency management system 115, selecting a link or URL (e.g., in a browser application) to download an application installer. Examples of software dependency managers can include npm, pip, docker, apt, yum, brew, go modules, and cargo (rust crates). In some embodiments, the request is an HTTP/S request. In other embodiments, the request can be an FTP, SFTP, or SSH request. In some embodiments, where the proxy server 120 receives IP traffic from a transparent proxy, the proxy server 120 is capable of supporting multiple layer-7 protocols. In one embodiment, the request can identify a software package requested for installation.

The proxy server 120 is an intermediary device that is configured to receive, or intercept, all requests from the client device 105, evaluate the requests and/or responses to the requests, and enforce any security policies. In one embodiment, the proxy server 120 is a forward proxy. In some embodiments, the proxy server 120 evaluates the request to determine if the request is for a software installation. For example, the request can identify the software installation being requested (e.g., from a URL, link, checksum, etc.).

In some embodiments, where the proxy server 120 cannot determine if the request is for a software installation, the proxy server 120 can defer enforcing policies on the request and send the request to the software dependency server 130. Upon receiving a response from the software dependency server 130 with the software package for installation, the proxy server 120 can evaluate the response to identify whether the response matches any security policies (e.g., by identifying a filename, file extension, and/or checksum in the response).

By intercepting requests from the client device 105, the proxy server 120 can prevent the client device 105 from directly accessing resources outside of a private network to prevent the client device 105 from compromising data and enterprise resources (e.g., through the unintentional installation or the uploading of malicious applications or programs).

In some embodiments, the software dependency management system 115 is configured such that software installation requests are proxied to the proxy server 120 by setting an HTTP_PROXY variable as follows: “HTTPS_PROXY={forward_proxy} {filter}.” In other embodiments, the HTTP_PROXY variable is not set and the proxy server 120 receives the request differently. For example, the client device 105 may include an agent that forwards all traffic to the proxy server 120. As another example, the client device 105 may be connecting through a router that is configured with a tunnel to the proxy server 120 (e.g., a GRE tunnel, an IPsec tunnel, or other tunnel) such that all traffic is forwarded to the proxy server 120. In another example, the client network application 110 can be configured with a proxy auto-configuration (PAC) file that causes requests to be sent to the proxy server 120. As another example, a proxy endpoint can be used to forward requests to the proxy server 120. In another example, clientless remote browsing isolation (RBI) can be used that is configured to send requests to the proxy server 120. As another example, DNS based security policies can override the response IP address of hosts that serve software dependencies, causing connections to be routed through the proxy server 120. In such configurations, the operating system or dependency management software is configured to accept the root HTTPS certificate the proxy server 120 uses to sign and encrypt traffic.

In other embodiments, a client-side transparent proxy can be used to receive traffic from the client device 105. In such embodiments, network rules on the client device 105 can be configured to send all of the internet traffic from the client device 105 to a local proxy daemon. The local proxy daemon may have installed a local trusted CA certificate to enable the service to man-in-the-middle the HTTPS connections of the client device 105. The local proxy daemon can then send all of the internet traffic to the proxy server 120.

In some embodiments, in response to receiving the request for the software dependency installation, the proxy server 120 queries a vulnerability management database 140 at operation 1.4. In one or more embodiments, the proxy server 120 queries the vulnerability management database using the name of the software dependency installation package, or an identifier associated with the software dependency installation package. Examples of vulnerability management databases 140 can include software CVE vulnerability databases, IP/ASN reputation databases, DNS categorization databases, software checksum databases, or user provided databases. The vulnerability management databases 140 can include an installation package properties/scores database 142. The installation package properties/scores database 142 can store risk scores and/or confidence scores associated with the requested software dependency installation that are received or retrieved by the proxy server 120 (e.g., from threat intelligence and CVE databases). The installation package properties/scores database 142 can also store information regarding a reputation of IP addresses and Autonomous System Numbers (ASN) of the server being contacted and the country assignments of IP addresses and ASNs. The installation package properties/scores database 142 can also include information regarding domains including whether they are newly registered and categorizations, and whether the domain name is a known software dependency hosting service (e.g., github, gitlab, bitbucket, etc.). The proxy server 120 can further identify properties of the request. In some embodiments, the proxy server 120 uses the identified properties of the request to calculate checksums.

Using the received data from the vulnerability management database 140 and policies stored in the policies database 124, the proxy server 120 enforces policies on the request at operation 1.5. In one embodiment, the proxy server 120 includes a policy enforcer 122 configured to enforce the policies stored in the policies database 124 on requests. In addition to policies based on risk scores and confidence scores, policies can include host/IP allow lists and deny lists, software checksum allow lists and deny lists, software license allow lists and deny lists, and inspection of received data using pattern matching, machine learning or static analysis. These lists can be generated by the policy enforcer 122 or by third parties or provided by customers in the policies configuration data described previously. For example, deny lists can indicate known vulnerable software dependency installation packages. Policies can be directed to all software dependency installations. In some embodiments, policies can be directed to specific identities. For example, a policy can be directed to specific user identifiers and/or client device identifiers to either allow or deny requests from the specific user and/or client devices. In some embodiments, policies can apply to vulnerabilities or techniques detected in source code, for example, use of error-prone functions with safer alternatives, such as memcopy/memcopy_s in the C programming language, or variable interpolation within SQL statements.

Based on the policies, the policy enforcer 122 can either approve or deny the request for the software dependency installation at operation 1.6. In one embodiment, the proxy server 120 can further detect vulnerable transitive and sub-dependencies. For example, the proxy server 120 can scan the software dependency installation and parse it into a software bill of materials, including the libraries imported by that piece of software, or a build artifact (e.g., a docker image).

The proxy server 120 can log the result of the policy enforcement in an auditing system 150. The auditing system 150 can be a third party system or part of the proxy server 120. In one embodiment, the audit logs 152 can be used for threat assessments to identify vulnerable software within a network (e.g., a private network) or by external threat detection systems. In some embodiments, the audit logs 152 can be used for security incident response purposes to assist in addressing and/or managing a security breach or cyberattack.

When the proxy server 120 approves the request for the software dependency installation, the approval is logged in audit logs 152 at operation 1.7A. In one embodiment, the audit logs 152 can store information about the approved request for the software dependency installation, including a software version of the software dependency installation. The proxy server 120 sends the request to the software dependency server 130 at operation 1.8A. The software dependency server 130 can then process the request and generate a response with the software dependency that is sent to the proxy server 120 at operation 1.9A. The proxy server 120 then sends the software dependency to the software dependency management system 115 at operation 1.10A.

When the proxy server 120 denies the request for the software dependency installation, the denial is logged in audit logs 152 at operation 1.7B. In one embodiment, the proxy server 120 can send information to the auditing system 150 indicating the denial of the request for the software dependency installation, including an indication of the policy the request violated. In some embodiments, the proxy server 120 can return an error response or notification message to the client device 105 indicating the denial of the request at operation 1.8B. In one embodiment, the error response can be a customizable block page. For non-HTTP requests, a notification can be displayed via a client network application (e.g., an agent on the client device).

In embodiments where the proxy server 120 enforces policies on a response from the software dependency server 130 with the software package for installation, the proxy server 120 evaluates properties of the response (e.g., a filename, file extension, software licenses, and/or checksum). The proxy server 120 enforces policies based on the response to approve or block the software installation package from being sent to the software dependency management system 115.

In some embodiments, the requests from the client device 105 to download and install software dependency installation packages can be for OCI/Docker images. In such embodiments, the policies database 124 can include policies specific to OCI/Docker images (e.g., only allow Docker pulls from approved Docker repositories, only pull from images published by approved publishers, etc.). Further, when the proxy server 120 receives a software dependency installation package in the form of an OCI/Docker image request, the proxy server 120 scans them by parsing the image that the client is requesting, breaking the image down into a software bill of materials. The proxy server 120 then queries the vulnerability management database 140 for each dependency within the image. In some embodiments, the container image version may also have entries in the vulnerability management database 140.

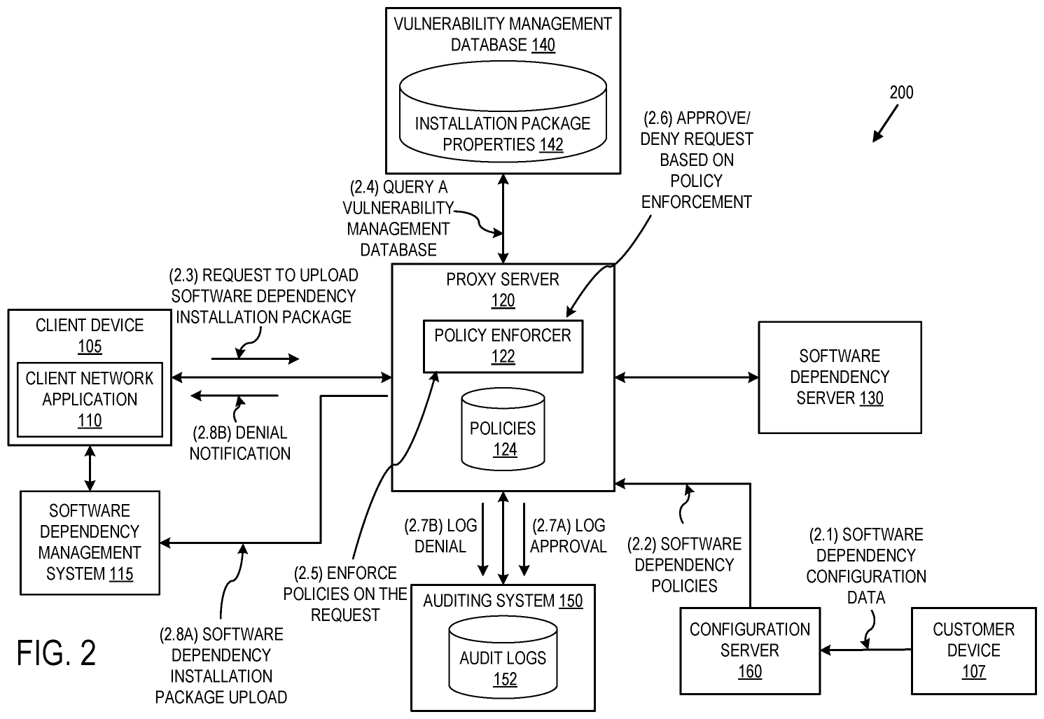

FIG. 2 illustrates an exemplary networked system according to some embodiments described herein. The exemplary networked system 200 illustrated in FIG. 2 includes a proxy server 120 situated between a client device 105 and a software dependency server 130. The exemplary networked system 200 also includes a vulnerability management database 140, an auditing system 150, and a configuration server 160 that are connected and/or communicate with the proxy server 120. The embodiment depicted in FIG. 2 illustrates operations for handling requests from the client device 105 to upload software dependency installation packages to a software dependency management system 115.

Examples of client device 105 and customer device 107 include computing devices (e.g., laptops, workstations, smartphones, palm tops, mobile phones, tablets, gaming systems, set top boxes, wearable devices, electronic devices, etc.) that are capable of transmitting and/or receiving network traffic. In some embodiments, client device 105 executes a client network application 110 that is capable of transmitting and/or receiving network traffic. For example, the client network application 110 may be a web browser or other application that can send requests to access and display network resources, including software dependency installations.

In one embodiment, the configuration server 160 receives policies configuration data from the customer device 107 at operation 2.1. In one embodiment, the configuration server 160 allows a user of the customer device 107 to configure settings and parameters for security policies that apply to installations requests and software upload requests from the client device 105. The policies configuration data can be used by the configuration server 160 to create policies defining a security posture for client devices (e.g., client device 105). An example policy includes allowing software installation if the software has a Common Vulnerabilities and Exposures (CVE) score of “Medium” or lower (e.g., a score of less than 4 out of 10).

In some embodiments, the configuration server 160 receives policies configuration data to, additionally or alternatively, configure settings and parameters for software license compliance policies that apply to software dependency installation requests and software upload requests from the client device 105. The configuration data can be used by the configuration server 160 to create policies for enforcing software license compliance for client devices (e.g., client device 105). An example policy includes allowing software installation if the software uses a permissive license such as the MIT license, while prohibiting software dependencies that use copyleft licenses such as European Union Public Licenses (EUPL).

After the configuration server 160 generates the software dependency policies, the configuration server 160 can send the software dependency policies to the proxy server at operation 2.2 for storage in a policies database 124.

A request to upload a software dependency installation package to the software dependency management system 115 is received at the proxy server 120 from client network application 110 at operation 2.3. The request can be generated following the user of the client device 105 downloading a software dependency installation package to the client device 105. Examples of software dependency managers can include npm, pip, docker, apt, yum, brew, go modules, and cargo (rust crates). Different software dependency managers can be used for different functions. For example, some software dependency installation methods, such as apt, yum, and brew, are typically used to install system dependencies where libraries, headers and artifacts are compiled for a given architecture and system. Other software dependency installation methods, such as npm, yarn, pip, gem, and java, install platform independent code, but can be compiled (e.g. for JavaScript transpiled, for Java compiled to bytecode, etc). Software dependency installation methods go mod and rust fetch source code, while docker fetches docker images. In some embodiments, the request is an HTTP request. The request can also be an FTP, SFTP, or SSH request. In one embodiment, the request can identify a software package requested for installation.

The proxy server 120 is an intermediary device that is configured to receive, or intercept, all requests from the client device 105, evaluate the requests, and enforce any security policies before allowing the request to proceed to its intended destination. In one embodiment, the proxy server 120 is a forward proxy. By intercepting requests from the client device 105, the proxy server 120 can prevent the client device 105 from directly accessing resources outside of a private network to prevent the client device 105 from compromising data and enterprise resources (e.g., through the unintentional installation or the uploading of malicious applications or programs).

In some embodiments, the software dependency management system 115 is configured such that requests to upload software dependency installation packages are proxied to the proxy server 120 by setting an HTTP_PROXY variable as follows: “HTTPS_PROXY={forward_proxy} {filter}.” In other embodiments, the HTTP_PROXY variable is not set and the proxy server 120 can receive the request via a WARP client, a GRE tunnel, an IPsec tunnel, a proxy endpoint, a clientless RBI, etc.

In some embodiments, in response to receiving the request to upload the software dependency installation package, the proxy server 120 queries a vulnerability management database 140 at operation 2.4. In one or more embodiments, the proxy server 120 queries the vulnerability management database using the name of the software dependency installation package, or an identifier associated with the software dependency installation package. The vulnerability management databases 140 can include an installation package properties/scores database 142. The installation package properties/scores database 142 can store risk scores and/or confidence scores associated with the requested software dependency installation that are received or retrieved by the proxy server 120. The proxy server 120 can further identify properties of the request. In some embodiments, the proxy server 120 uses the identified properties of the request to calculate checksums. In some embodiments, the proxy server 120 uses the identified properties of the request to evaluate the package for risks of security vulnerabilities and exposures using pattern matching, machine learning models, or static analysis.

Using the received data from the vulnerability management database 140 and policies stored in the policies database 124, the proxy server 120 enforces policies on the request at operation 2.5. In one embodiment, the proxy server 120 includes a policy enforcer 122 configured to enforce the policies stored in the policies database 124 on requests. In addition to policies based on risk scores and confidence scores, policies can include host/IP allow lists and deny lists, software checksum allow lists and deny lists, and software license allow lists and deny lists. These lists can be generated by the policy enforcer 122 or by third parties or provided by customers in the policies configuration data described previously. Policies can be directed to all software dependency installations. In some embodiments, policies can be directed to specific identities. For example, a policy can be directed to specific users and/or client devices to either allow or deny requests from the specific user and/or client devices.

Based on the policies, the policy enforcer 122 can either approve or deny the request to upload the software dependency installation package at operation 2.6. In one embodiment, the proxy server 120 can further detect vulnerable transitive and sub-dependencies. For example, the proxy server 120 can scan the software dependency installation and parse it into a software bill of materials, including the libraries imported by that piece of software, or a build artifact (e.g., a docker image).

The proxy server 120 can log the result of the policy enforcement in an auditing system 150. The auditing system 150 can be a third party system or part of the proxy server 120. In one embodiment, the audit logs 152 can be used for threat assessments to identify vulnerable software within a network (e.g., a private network) or by external threat detection systems.

When the proxy server 120 approves the request to upload the software dependency installation package, the approval is logged in audit logs 152 at operation 2.7A. The proxy server 120 then allows the upload of the software dependency installation package to the software dependency management system 115 at operation 2.8A.

When the proxy server 120 denies the request to upload the software dependency installation package, the denial is logged in audit logs 152 at operation 2.7B. In one embodiment, the proxy server 120 can send information to the auditing system 150 indicating the denial of the request for the software dependency installation, including an indication of the policy the request violated. In some embodiments, the proxy server 120 can return an error response or notification message to the client device 105 indicating the denial of the request at operation 2.8B. In one embodiment, the error response can be a customizable gateway block page. For non-HTTP requests, a notification can be displayed via a client network application (e.g., a WARP client).

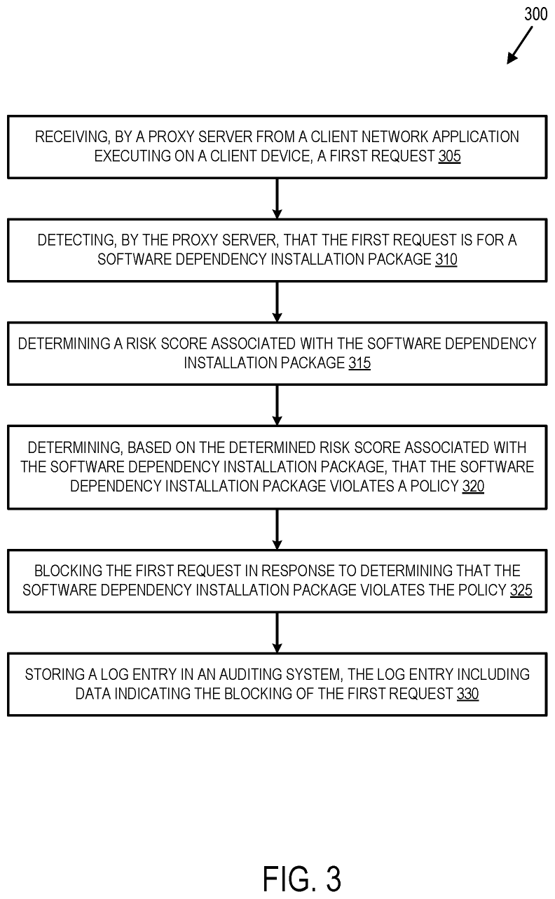

FIG. 3 is a flow diagram 300 that illustrates exemplary operations for performing security operations on a request for a software dependency installation in a software dependency management system by a proxy server according to an embodiment The operations of FIG. 3 will be described with reference to the exemplary embodiment of FIG. 1. However, it should be understood that the operations of FIG. 3 can be performed by embodiments of the invention other than those discussed with reference to FIG. 1, and the embodiments discussed with reference to FIG. 1 can perform operations different than those discussed with reference to FIG. 3. The operations of FIG. 3 are described as being performed by a proxy server (e.g., proxy server 120). In one embodiment, the proxy server 120 is a forward proxy.

In operation 305, a proxy server receives, from a client network application executing on a client device, a first request. In one embodiment, the first request is an HTTP request. The request can be generated in response to a user, while logged into a software dependency management system, selecting a link or URL (e.g., in a browser application) to download an application installer. In other embodiments, the first request can be an FTP, SFTP, or SSH request. The first request can be directed to a resource in a software dependency management system.

The proxy server is an intermediary device that is configured to receive, or intercept, all requests from the client device, evaluate the requests, and enforce any security policies before allowing the request to proceed to its intended destination. By intercepting requests from the client device, the proxy server can prevent the client device from directly accessing resources outside of a private network to prevent the client device from compromising data and enterprise resources (e.g., through the unintentional installation or the uploading of malicious applications or programs).

In operation 310, the proxy server detects that the first request is for a software dependency installation package. In one embodiment, the first request can identify the software dependency installation package requested for installation.

In operation 315, the proxy server determines a risk score associated with the software dependency installation package. In some embodiments, the proxy server queries a vulnerability management database (e.g., using a name of, or an identifier associated, with the software dependency installation package). The vulnerability management databases can include an installation package properties/scores database that stores risk scores and/or confidence scores associated with software dependency installation packages.

In operation 320, the proxy server determines based on the determined risk score associated with the software dependency installation package, that the software dependency installation package violates a policy. In one embodiment, the software dependency installation package violates the policy when the determined risk is above a risk threshold or outside of a threshold range. In some embodiments, the proxy server obtains the properties associated with the first request from a vulnerability management database. In some embodiments, the proxy server can also derive or identify properties from the first request itself.

In one embodiment, the proxy server accesses a set of policies from a policies database to identify the policy. Policies can be directed to specific identities (e.g., users or machines), to specific software dependency installation packages and/or to the software dependency management system. In some embodiments, the proxy server receives the set of policies from a configuration server, where the set of policies are generated using received configuration data (e.g., from a user associated with the software dependency management system).

Properties associated with the first request can include a risk score associated with the software dependency installation package. For example, based on the set of policies associated with the software dependency management system, the proxy server can compare the risk score associated with the software dependency installation package with a risk threshold identified in the set of policies. If the risk score exceeds the risk threshold (e.g., does not conform to the set of policies), the downloading of the software dependency installation package can be denied. However, if the risk score does not exceed the risk threshold (e.g., conforms to the set of policies), the downloading of the software dependency installation package can be allowed and the request can be transmitted to a software dependency manager. In some embodiments, after determining whether to allow or deny the request for the downloading of the software dependency installation package, the determination can be stored in a log entry of an auditing system.

In operation 325, the proxy server blocks the first request in response to determining that the software dependency installation package violates the policy. In one embodiment, the proxy server generates a notification message indicating the blocking of the first request from transmission to a software dependency manager. The proxy server can then transmit the notification message to the client device.

In operation 330, the proxy server stores a log entry in an auditing system, the log entry including data indicating the blocking of the first request. In one embodiment, the proxy server can send information indicating the denial of the request for the software dependency installation, including an indication of the policy the request violated.

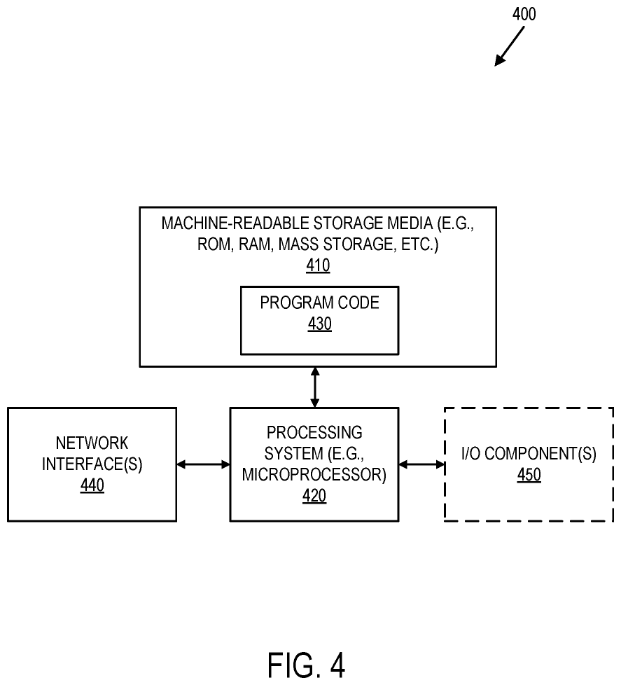

FIG. 4 illustrates a block diagram for an exemplary data processing system 400 that may be used in some embodiments. One or more such data processing systems 400 may be used to implement the embodiments and operations described with respect to the data centers, origin server, control server, or other electronic devices. The data processing system 400 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 410 (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals), which is coupled to the processing system 420 (e.g., one or more processors and connected system components such as multiple connected chips). For example, the depicted machine-readable storage media 410 may store program code 430 that, when executed by the processing system 420, causes the data processing system 400 to perform any of the operations described herein.

The data processing system 400 also includes one or more network interfaces 440 (e.g., a wired and/or wireless interfaces) that allows the data processing system 400 to transmit data and receive data from other computing devices, typically across one or more networks (e.g., Local Area Networks (LANs), the Internet, etc.). The data processing system 400 may also include one or more input or output (“I/O”) components 450 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices.

Additional components, not shown, may also be part of the data processing system 400, and, in certain embodiments, fewer components than that shown in FIG. 4 may also be used in a data processing system 400. One or more buses may be used to interconnect the various components shown in FIG. 4.

Thus, an electronic device (e.g., a computer or a mobile client device) includes hardware and software, such as a set of one or more processors coupled to one or more machine-readable storage media to store code for execution on the set of processors and/or to store data. For instance, an electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

The techniques shown in the figures can be implemented using code and data stored and executed on one or more computing devices (e.g., client devices, servers, etc.). Such computing devices store and communicate (internally and/or with other computing devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals-such as carrier waves, infrared signals, digital signals, etc.). In addition, such computing devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given computing device typically stores code and/or data for execution on the set of one or more processors of that computing device. Of course, one or more parts of an embodiment of the invention may be implemented using different combinations of software, firmware, and/or hardware.

In the preceding description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment.” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the preceding description and the claims, the terms “coupled” and “connected.” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A computer-implemented method comprising:
receiving, by a proxy server from a client network application executing on a client device, a first request;
detecting, by the proxy server, that the first request is for a software dependency installation package;
determining a risk score associated with the software dependency installation package;
determining, based on the determined risk score associated with the software dependency installation package, that the software dependency installation package violates a policy;
blocking the first request in response to determining that the software dependency installation package violates the policy; and
storing a log entry in an auditing system, the log entry including data indicating the blocking of the first request.

2. The computer-implemented method of claim 1, further comprising:
receiving configuration data from a software dependency management system, the configuration data including settings and parameters for security policies for software dependency installation packages; and
generating a set of policies based on the received configuration data.

3. The computer-implemented method of claim 1, wherein blocking the first request in response to determining that the software dependency installation package violates the policy comprises:
transmitting a notification message to the client device indicating the blocking of the first request from transmission to a software dependency manager.

4. The computer-implemented method of claim 1, further comprising:
receiving a set of policies associated with a software dependency management system from a configuration server, wherein one or more policies in the set of policies are associated with a client device identifier.

5. The computer-implemented method of claim 1, further comprising:
receiving, by the proxy server from the client network application executing on the client device, a second request;
detecting, by the proxy server, that the second request is for a second software dependency installation package;
determining that the second software dependency installation package is on a deny list; and
blocking the second request in response to determining that the second software dependency installation package is on the deny list.

6. The computer-implemented method of claim 1, further comprising:
receiving, by the proxy server from the client network application executing on the client device, a second request;
detecting, by the proxy server, that the second request is for a second software dependency installation package;
determining a second risk score associated with the second software dependency installation package;
determining, based on the determined second risk score associated with the second software dependency installation package, that the second software dependency installation package conforms to the policy; and
transmitting the second request to a software dependency manager in response to determining that the second software dependency installation package conforms to the policy.

7. The computer-implemented method of claim 1, wherein determining the risk score associated with the software dependency installation package comprises:
querying a vulnerability management database with an identifier for the software dependency installation package.

8. A non-transitory machine-readable storage medium that provides instructions that, if executed by a processor, will cause said processor to perform operations comprising, comprising:
receiving, by a proxy server from a client network application executing on a client device, a first request;
detecting, by the proxy server, that the first request is for a software dependency installation package;
determining a risk score associated with the software dependency installation package;
determining, based on the determined risk score associated with the software dependency installation package, that the software dependency installation package violates a policy;
blocking the first request in response to determining that the software dependency installation package violates the policy; and
storing a log entry in an auditing system, the log entry including data indicating the blocking of the first request.

9. The non-transitory machine-readable storage medium of claim 8, wherein the operations further comprise:
receiving configuration data from a software dependency management system, the configuration data including settings and parameters for security policies for software dependency installation packages; and
generating a set of policies based on the received configuration data.

10. The non-transitory machine-readable storage medium of claim 8, wherein blocking the first request in response to determining that the software dependency installation package violates the policy comprises:
transmitting a notification message to the client device indicating the blocking of the first request from transmission to a software dependency manager.

11. The non-transitory machine-readable storage medium of claim 8, wherein the operations further comprise:
receiving a set of policies associated with a software dependency management system from a configuration server, wherein one or more policies in the set of policies are associated with a client device identifier.

12. The non-transitory machine-readable storage medium of claim 8, wherein the operations further comprise:
receiving, by the proxy server from the client network application executing on the client device, a second request;
detecting, by the proxy server, that the second request is for a second software dependency installation package;
determining that the second software dependency installation package is on a deny list; and
blocking the second request in response to determining that the second software dependency installation package is on the deny list.

13. The non-transitory machine-readable storage medium of claim 8, wherein the operations further comprise:
receiving, by the proxy server from the client network application executing on the client device, a second request;
detecting, by the proxy server, that the second request is for a second software dependency installation package;
determining a second risk score associated with the second software dependency installation package;
determining, based on the determined second risk score associated with the second software dependency installation package, that the second software dependency installation package conforms to the policy; and
transmitting the second request to a software dependency manager in response to determining that the second software dependency installation package conforms to the policy.

14. The non-transitory machine-readable storage medium of claim 8, wherein determining the risk score associated with the software dependency installation package comprises:
querying a vulnerability management database with an identifier for the software dependency installation package.

15. A server, comprising:
a processor; and
a non-transitory machine-readable storage medium that provides instructions that, if executed by the processor, will cause the server to perform operations including:
receiving, by a proxy server from a client network application executing on a client device, a first request;
detecting, by the proxy server, that the first request is for a software dependency installation package;
determining a risk score associated with the software dependency installation package;
determining, based on the determined risk score associated with the software dependency installation package, that the software dependency installation package violates a policy;
blocking the first request in response to determining that the software dependency installation package violates the policy; and
storing a log entry in an auditing system, the log entry including data indicating the blocking of the first request.

16. The server of claim 15, wherein the operations further comprise:
receiving configuration data from a software dependency management system, the configuration data including settings and parameters for security policies for software dependency installation packages; and
generating a set of policies based on the received configuration data.

17. The server of claim 15, wherein blocking the first request in response to determining that the software dependency installation package violates the policy comprises:
transmitting a notification message to the client device indicating the blocking of the first request from transmission to a software dependency manager.

18. The server of claim 15, wherein the operations further comprise:
receiving a set of policies associated with a software dependency management system from a configuration server, wherein one or more policies in the set of policies are associated with a client device identifier.

19. The server of claim 15, wherein the operations further comprise:
receiving, by the proxy server from the client network application executing on the client device, a second request;
detecting, by the proxy server, that the second request is for a second software dependency installation package;
determining that the second software dependency installation package is on a deny list; and
blocking the second request in response to determining that the second software dependency installation package is on the deny list.

20. The server of claim 15, wherein the operations further comprise:
receiving, by the proxy server from the client network application executing on the client device, a second request;
detecting, by the proxy server, that the second request is for a second software dependency installation package;
determining a second risk score associated with the second software dependency installation package;
determining, based on the determined second risk score associated with the second software dependency installation package, that the second software dependency installation package conforms to the policy; and
transmitting the second request to a software dependency manager in response to determining that the second software dependency installation package conforms to the policy.

21. The server of claim 15, wherein determining the risk score associated with the software dependency installation package comprises:
querying a vulnerability management database with an identifier for the software dependency installation package.
